(19) United States
(12) Patent Application Publication
(10) Pub. No.: US 2015/0176764 A1
(43) Pub. Date: Jun. 25, 2015

(54) TANK

(71) Applicant: SeaCaptaur IP PTY Ltd., Osborne Park (AU)

(72) Inventor: Alan ROBERTS, Osborne Park (AU)

(21) Appl. No.: 14/636,569

(22) Filed: Mar. 3, 2015

Related U.S. Application Data
(63) Continuation-in-part of application No. PCT/AU2013/000972, filed on Aug. 29, 2013.

(30) Foreign Application Priority Data
Sep. 3, 2012 (AU) 2012903826

(51) Int. Cl. F17C 1/00; F17C 5/02; E04H 7/02

(52) U.S. Cl. CPC F17C 1/007; E04H 7/02; F17C 5/02

(57) ABSTRACT

A tank for storage of hydrocarbon liquids on the seabed, being of double hull construction which is compartmented to form a plurality of chambers, such that the tank may be safely towed from its build location or shipyard, to offshore deployment location as marine warranty compliant vessel, having appropriate intact and damaged stability characteristics. There is also provided a method for deploying a tank for storage of hydrocarbon liquids on the seabed, the method comprising the step of towing the tank having un-ballasted storage areas and compartments to the location of deployment; flooding at least partially the storage area to achieve substantial neutral buoyancy of the tank to allow decent of the tank up to a submerged equilibrium; allowing decent of the tank to the seabed and injecting air into at least one compartment for maintaining equilibrium between the pressure applied by the surrounding sea and the pressure inside compartments and storage area.

This application is a Continuation-in-Part of PCT/AU2013/000972, filed 29 Aug. 2013, which claims benefit of Serial No. 2012903826, filed 3 Sep. 2012 in Australia and which applications are incorporated herein by reference. To the extent appropriate, a claim of priority is made to each of the above-disclosed applications.

### TECHNICAL FIELD

The present invention relates to hydrocarbon liquid storage offshore.

The invention has been devised particularly, although not necessarily solely, in relation to subsea hydrocarbon liquid storage.

### BACKGROUND ART

The following discussion of the background art is intended to facilitate an understanding of the present invention only. The discussion is not an acknowledgement or admission that any of the material referred to is or was part of the common general knowledge as at the priority date of the application.

Typically, offshore hydrocarbon processing takes place at either: a fixed platform with wells on surface, or subsea wells connected by pipeline and control umbilical to a fixed platform, or subsea wells connected by pipeline and control umbilical to a vessel on surface. In the case of a vessel on surface, the vessel is required to be moored or connected to the seafloor by a spread mooring, connected to a swivel attached to the vessel, allowing the vessel to weathervane, to mitigate wind and wave forces.

In deeper water, the vessel often takes less conventional forms, with proprietary mooring and fixing systems, such as a TLP (tension leg platform).

A vessel on surface is subject to the forces of the sea, which generate motions unfavourable to production operations, and transfers loads into the mooring system. The motions may be moderated by increasing the size of vessel, which in turn increases the forces, and increases the loads into and size of the moorings.

With motions so accommodated, there remains the problem of the many complex fluid/power/electronic signal interconnections between the subsea wells, and the vessel, which have to pass through the swivel.

The compound effect of sea forces and motions, impacts the minimum size of the vessel on surface, and the size of its mooring. This in turn impacts cost of building, installing and operating, consequently the minimum size of the resource, able to be commercially developed.

To break the cycle of a larger vessel being required to withstand the forces of the sea, which in turn requires a larger mooring, which in turn leads to cost and other impacts, it is preferable that the hydrocarbons be stored on the seabed, and thereby not being affected by those forces.

A vessel on surface is required to be designed to the requirements of the IMO (International Maritime Organisation) MARPOL Treaty, Regulations 13F and 13G which requires such a vessel to be of “double hull” construction.

It is against this background that the present invention has been developed.

### SUMMARY OF INVENTION

According to a first aspect of the invention, there is provided a tank for storage of hydrocarbon liquids on the seabed, being of double hull construction which is compartmented to form a plurality of chambers, such that the tank may be safely towed from its build location or shipyard, to offshore deployment location as marine warranty compliant vessel, having appropriate intact and damaged stability characteristics.

In an arrangement, the extent of compartmentalization of the double walls is such that if the tank is involved in a collision with another vessel, resulting in the flooding of a substantial number of compartments, the tank will remain afloat, and will have sufficient residual stability to be towed with care, to a safe harbour.

According to a second aspect of the invention, there is provided a tank for storage of hydrocarbon liquids on the seabed, being of double hull construction which is compartmented to form a plurality of compartments, where the ratio of volumetric space between the main storage area and the plurality of compartments is such that when the main storage area is fully flooded, the tank remains afloat, but may be sunk or submerged by controlled flooding of at least one of the plurality of the compartments.

Preferably, the ratio of volumetric space between the main storage area and the plurality of compartments is such that when only the main storage area is fully flooded, the tank is substantially in neutral buoyancy state and decent or ascent of the tank can be managed by flooding or expelling water from at least one compartment.

According to a third aspect of the invention, there is provided a tank for storage of hydrocarbon liquids on the seabed, of double hull construction where the ratio of volumetric space between the main storage area and the at least one compartment is such that when the tank is on the seabed in the flooded state, the tank may be recovered to surface by controlled air injection into the at least one compartment and controlled water release from the at least one compartment.

According to a third aspect of the invention, there is provided a tank for storage of hydrocarbon liquids on the seabed, the tank comprising a main storage area having a compartment, an outer side wall, and an inner side wall defining an hollow wall surrounding the compartment of the main storage area, the hollow wall being configured to be selectively displaced between flooded conditions and purged conditions to control descent and/or ascent of the tank, wherein the outer side wall comprises a first outer layer and a second inner layer that is distance inboard with respect to the first outer layer to define a first space between the first inner and outer layers, the first space being permanently sealed.

Preferably, the first space is configured to define a plurality of sealed compartments.

Preferably, the tank further comprises a bottom comprising a second outer layer and a second inner layer that is distance inboard with respect to the second outer layer to define a second space between the second inner and outer layers, the second space being permanently sealed.

Preferably, the hollow wall is configured to define a plurality of second compartments, the plurality of second compartments are adapted to be selectively displaced between flooded conditions and purged conditions to control descent and/or ascent of the tank.

Preferably, the ratio of volumetric space between the main storage area and the plurality of second compartments is such that (1) when the main storage area is fully flooded, the tank remains afloat, but may be sunk or submerged by controlled flooding of at least one of first second compartments; (2) when the tank is on the seabed in the flooded state, the tank may be recovered to surface by controlled air injection into at least one second compartment and controlled water release from the at least one second compartments.

According to a fourth aspect of the invention comprises a tank having a main storage area bounded by double walls which are compartmented to form a plurality of compartments which when being deployed to or recovered from the seabed, is adapted to allow the compartments to be selectively flooded, by means of controlled air release or selectively emptied by water being expelled from at least one of the selected compartments by air injection, in such a manner that the pressures in the main storage area and the compartments are substantially in equilibrium with the external hydrostatic pressure of the surrounding sea, thereby preventing implosion or bursting of the tank.

A tank for storage of hydrocarbon liquids on the seabed, the tank comprising a main storage area having a first compartment for storage of the hydrocarbon liquids, an outer side wall, and an inner side wall defining an hollow wall surrounding the first compartment, the hollow wall is configured to define a plurality of second compartments, the plurality of second compartments being adapted to be selectively displaced between flooded conditions and purged conditions to control submersion of the tank onto the seabed and to control ascension of the tank from the seabed, wherein the tank is adapted to:
(a) fully flood the first compartment of the storage area and flood at least partially at least one compartment of the plurality of second compartments to submerge the tank onto the seabed, and to inject air into another at least one compartment of the plurality of second compartments to control submersion of the tank onto the seabed, and
(b) inject air into the at least one compartment of the plurality of second compartments that is at least partially flooded to allow controlled evacuation of water therefrom to control ascension of the tank from the seabed.

Preferably, the tank is adapted to allow selection of which of the at least one compartment of the second compartments are to be at least partially flooded and which of the another at least one compartment of the second compartments are to be injected with air to control submersion of the tank onto the seabed

Preferably, the tank comprises: connecting piping, valves, pressure and water level monitoring devices, adapted to allow compartment selection and remote monitoring during: flooding, water expulsion, air injection and air release, by means of a control umbilical cable, to a vessel on surface.

Preferably, the tank comprises a cylindrical body, the diameter of the cylindrical body being about 25 meters and having about a height of 20 meters, the side walls being about 1 meter separation and the mass of the tank 1 being about 1500 tonne.

Preferably, the tank comprises an upper plate and a lower plate, the upper and lower plate being compartmented to form a plurality of compartments.

Preferably, the tank complies with Regulation 19 dated 1992 of Annex I of the International Convention for the Prevention of Pollution from Ships (MARPOL).

Preferably, the tank comprising a double wall and an entrapped water layer between the hydrocarbons and the surrounding sea for reducing the rate of heat loss to the surrounding sea and facilitating thermal management of the hydrocarbons stored in the tank.

Preferably, the outer side wall comprises a first outer layer and a second inner layer that is distance inboard with respect to the first outer layer to define a first space between the first inner and outer layers, the first space being permanently sealed.

According to a sixth aspect of the invention, there is provided a tank for storage of hydrocarbon liquids on the seabed, the tank comprising a main storage area having a compartment, an outer side wall, and an inner side wall defining an hollow wall surrounding the compartment of the main storage area, the hollow wall being configured to be selectively displaced between flooded conditions and purged conditions to control descent and/or ascent of the tank, wherein the outer side wall comprises a first outer layer and a second inner layer that is distance inboard with respect to the first outer layer to define a first space between the first inner and outer layers, the first space being permanently sealed and comprises an entrapped water layer between the hydrocarbons and the surrounding sea for reducing the rate of heat loss to the surrounding sea and facilitating thermal management of the hydrocarbons stored in the tank.

According to a seventh aspect of the invention, there is provided a method for submersion of a tank for storage of hydrocarbon liquids onto the seabed, the tank comprising a main storage area having a first compartment for storage of hydrocarbon liquids, an outer side wall, and an inner side wall defining a hollow wall surrounding the first compartment of the main storage area, the hollow wall configured to define a plurality of second compartments adapted to be selectively displaced between flooded conditions and purged conditions to control submersion of the tank onto the seabed, the method comprising the steps of:
fully flooding the storage area;
at least partially flooding at least one first compartment of the plurality of second compartments to achieve substantial neutral buoyancy of the tank; and
control flooding of the at least one first compartment of the plurality of second compartments to control submersion of the tank onto the seabed and injecting air into another at least one second compartment of the plurality of second compartments to maintain equilibrium between the pressure applied by the surrounding sea and the pressure inside the another at least one second compartment and the storage area.

Preferably, the method further comprises the step of selection which of the at least one compartment of the second compartments are to be at least partially flooded and which of the another at least one compartment of the second compartments are to be injected with air to control submersion of the tank onto the seabed.

According to an eight aspect of the invention, there is provided a method
for retrieving a tank for storage of hydrocarbon liquids from a seabed, the tank comprising a main storage area having a first compartment fully flooded, an outer side wall, and an inner side wall defining a hollow wall surrounding the compartment of the main storage area, the hollow wall configured to define a plurality of compartments adapted to be selectively displaced between flooded conditions and purged conditions to control descent of the tank, the method comprising the step of:
inserting air in the flooded compartments of the second compartments and allowing ascend of the tank to the water surface, wherein the inserting of air into the compartments of the second compartments is done in a controlled manner to avoid uncontrolled ascent caused by unrestrained air space expansion, as external hydrostatic pressure reduces with reduced submergence.

Preferably, the method further comprises the step of selection of which of the second compartments are at least partially evacuated to control ascension of the tank onto the seabed.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIGS. 1a and 1b are a schematic Side View (1a) and a Plan View (1b) of the tank in accordance with an embodiment of the invention;

FIGS. 2a, 2b and 2c show the process of deployment of the tank onto the seafloor.

### DESCRIPTION OF EMBODIMENTS

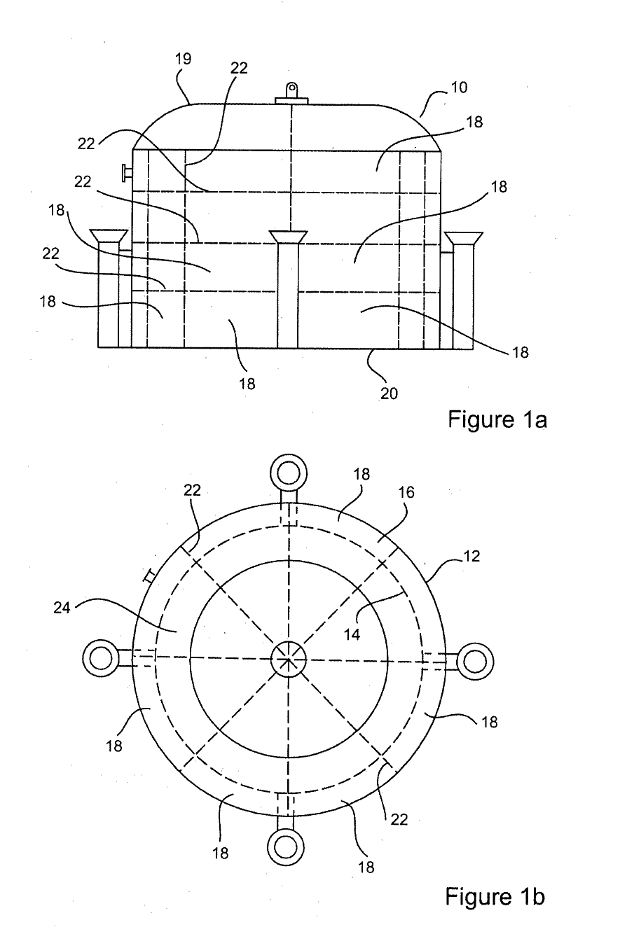

FIGS. 1a and 1b show a tank 10 in accordance with an embodiment of the invention. It should be noted that the FIGS. 1a and 1b are schematic only, and include phantom lines to show the internal structure of the tank.

Referring to FIGS. 1a and 1b, the tank 10 comprises an outer side wall 12 and an inner side wall 14 defining a hollow wall 16. The tank further comprises an upper plate 19, and a lower plate 20. The phantom lines shown in FIGS. 1a and 1b depict the inner side wall 14 as well as vertical and horizontal bulkheads 22 extending between the inner and outer side wall 12 and 14. The bulkheads 22 provide structural integrity to the hollow wall 16 defined by the inner and outer side walls 12 and 14.

The hollow wall 16 may be compartmentalized to form a plurality of compartments or chambers 18. The compartments 18 allow controlled flooding and evacuation of void space located between the outer and inner side walls 12 and 14, during sinking and recovery of the tank 10. The inner side wall 14 surround a storage area 24.

In an arrangement, the tank may comprises at least one wall section which is of double hull constructions. For example, the bottom and sides of the tank may have two complete layers of watertight hull surface: one outer layer forming the normal hull of the tank, and a second inner hull which is some distance inboard, which forms a redundant barrier. This barrier is particularly useful if the outer hull is damaged and leaks.

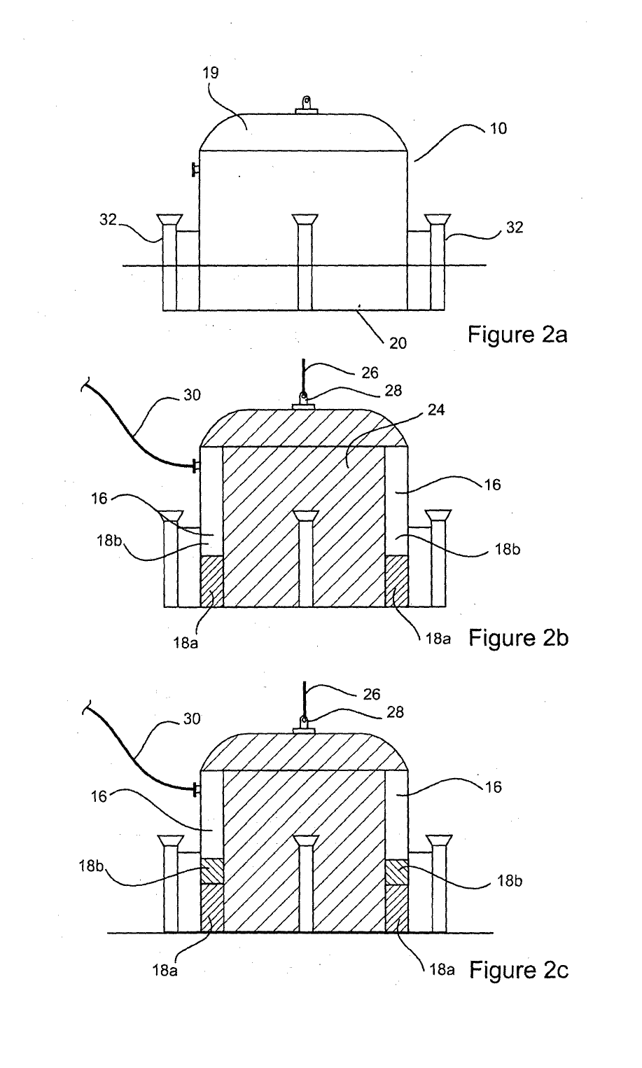

FIGS. 2a, 2b and 2c, show tank 10 in accordance with an embodiment of the invention, during the deployment process to the seabed. It should be noted that FIGS. 2a, 2b and 2c are schematic only, and the phantom lines appearing in FIGS. 1a and 1b are omitted to simplify.

FIG. 2a depicts the tank 10 after towing to the deployment location with no parts (such as the storage area 24 and the compartments 18) flooded. FIG. 2b depicts the tank 10 in submerged equilibrium, with the main storage space 24 fully flooded, and with selected compartments 18a flooded to achieve the submerged equilibrium (substantial neutral buoyancy of the tank) and the desired loading on lift appliance 26 floating on the water surface. FIG. 2c depicts the tank 10 on the seabed. The tank at this stage is substantially in the same state than the tank depicted in FIG. 2b, except that air has been injected into the compartments 18b which have not yet been flooded. This allows maintaining equilibrium between the pressure applied by the surrounding sea and the pressure inside compartments 18 and storage area 24.

Flooding of the compartments 18a during descend of tank 10 occurs usually as a single step at outset. The injection of air into the compartments 18b is a continuous process throughout the decent of the tank. Control of the flooding and air injection of the compartments 18 allows a managed decent of the tank. Thus, the lift point 28 allows a lift appliance 26 on the water surface to provide control of the decent of the tank 10 using significantly lower loads with respect to an unmanaged decent of the tank 10.

The volumetric ratio between the storage area 24 and the compartments 18 is such that the tank 10 is able to still remain stable during towing even if the tank is damaged and any one compartments 18 are flooded. The volumetric ratio between the storage area 24 and the compartments 18 is such that when the storage area 24 is flooded and none of the compartments are flooded, the tank 10 achieves substantial neutral buoyancy in preparation for decent to the seabed.

The tank 1 is adapted to connect a umbilical bundle 30 to convey air, water to and from the tank 10 for control of the decent as well as for retrieving the tank 10 up to the water surface. Sensors and controllers located on the tank 10 may also communicate through the umbilical bundle 30 to, for example, a vessel located on the surface. The sensors and controllers may, for example, communicate the particular state of the tank.

In another arrangement of the present embodiment of the invention, the upper plate 19 and the lower plate 20 comprise double walls which may be compartmented to define a plurality of compartments 18. These compartments 18 may also be selectively flooded or purged, and thus can play a further role in the hydrostatic manipulation during deployment and recovery of the tank.

Referring to FIGS. 1a and 1b, the tank 10 is adapted to have connection points 32, for fixing the tank 10 to the seafloor by means of piles (not shown), so as to resist hydrodynamic forces, and uplift due to stored hydrocarbon liquids having a specific gravity less than that of the surrounding seawater.

When tank 10 is so installed on the seabed, the storage area 24 and the plurality of compartments 18 are flooded with seawater, and hydrocarbon liquids are introduced into the storage area 24 by displacing the seawater contained in the area 24. This is known as “oil over water” storage. When hydrocarbon liquids are removed, seawater is allowed to re-enter, such that the tank is always filled with seawater and/or hydrocarbons.

The hollow wall 16 defined by the inner and outer side walls 12 and 14 act as a protective barrier, and containment barrier for leakage of hydrocarbons contained in the storage area 24, should leakage occur.

A particular arrangement of the tank 10 in accordance with the present embodiment of the invention is shown in FIGS. 1a and 1b. The tank 10 shown in FIGS. 1 and 2 comprises a cylindrical body. The diameter of the cylindrical body is 25 meters and has a height of 20 meters. The side walls 12 and 14 are 1 meter thick. The mass of the tank 1 is about 1500 tonne. The displacement is 9800 M³, being 8300 M³ provided by the main storage space 6 and 1500M³ provided by the compartments incorporated in the hollow wall of the tank 1.

In this particular arrangement of the tank 10, neutral buoyancy is achieved by the tank 10 when the storage area 24 is fully flooded with water and all of the compartments 18 are fully filed with air. At this point only sufficient water is introduced to provide the submerged weight to remain within the limits of the lifting appliance attached, for instance 50 tonnes, being 3.3% of the mass of the tank, but sufficient to assure ready but controlled submersion.

Typically, the relationship between the bottom pressure and the depth at which the tank 10 is located is as follows:

| Water Depth (m) | Bottom Pressure (psi) |
|---|---|
| 60 | 102 |
| 70 | 116 |
| 80 | 131 |
| 90 | 145 |
| 100 | 160 |

Once the tank 1 is lowered onto the seafloor (see FIG. 3c), the storage tank 10 is secured to the seafloor by skirt piles 12. This task involves driving, drilling and grouting or suction.

After deploying the tank 10 onto seafloor and securing to the seafloor, the tank 10 may be fluidly connected to production facilities to allow the processed hydrocarbon liquids to be stored in the tank 10.

Later recovery of the tank 10 is by the same process but reversed. Air is injected into the compartments 18. The release of water from the compartments 18 is controlled to avoid uncontrolled ascent caused by unrestrained air space expansion, as external hydrostatic pressure reduces with reduced submergence.

The method and procedure described above, may not necessarily or solely involve the use of the tank side wall, tank roof and floor compartments. In an alternative arrangement, chambers independent from the tank 10 may be also used to act as the compartment 18 to control towing and deployment of the tank 10. For example, external chambers may be attached to the outer walls 12 of the tank 1 or internal chambers may be incorporated in the tank 10.

The fact that the tank 10 comprises a body having a hollow wall is particularly advantageous because it provides a double containment of the stored hydrocarbons. This is particularly useful in the event of a leak.

It is evident that the present tank 10 is particularly advantageous for storing hydrocarbons from remote offshore locations. This is because the tank 1 allow a smaller storage unit to be contemplated, without mooring system, without a swivel, without seabed to surface interconnection, free of motions due to the sea and without crew and with the added advantage of the tank 10 being re-usable in view that it can be easily retrieved.

Modifications and variations as would be apparent to a skilled addressee are deemed to be within the scope of the present invention.

Further, it should be appreciated that the scope of the invention is not limited to the scope of the embodiments disclosed. For example the tank might be segmented for segregated storage of crude oil types, to limit free surface effects during flooding and recovery, and may have insulation or be fitted with immersion heaters to store high pour point crude oils.

Further, in an particular arrangement, the tank might be piped and instrumented to allow it to function as a separator, where gas is released via connections to the top of the tank, or water drain off points are fitted to the base of the tank, in fact acting as what is known colloquially in the hydrocarbons industry as a “gun barrel separator”.

Further, the number of piles guides, and piles into the seafloor may be altered with load case requirements.

Furthermore, any number of other liquid types might be stored on the seafloor.

In another arrangement, the tank may comprise a double wall and an entrapped water layer between the hydrocarbons and the surrounding sea for reducing the rate of heat loss to the surrounding sea and facilitating thermal management of the hydrocarbons stored in the tank.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

1. A tank for storage of hydrocarbon liquids on the seabed, the tank comprising a main storage area having a compartment, an outer side wall, and an inner side wall defining an hollow wall surrounding the compartment of the main storage area, the hollow wall being configured to be selectively displaced between flooded conditions and purged conditions to control descent and/or ascent of the tank, wherein the outer side wall comprises a first outer layer and a second inner layer that is distance inboard with respect to the first outer layer to define a first space between the first inner and outer layers, the first space being permanently sealed.

2. A tank according to claim 1 wherein the first space is configured to define a plurality of sealed compartments.

3. A tank according to claim 1 wherein the tank further comprises a bottom comprising a second outer layer and a second inner layer that is distance inboard with respect to the second outer layer to define a second space between the second inner and outer layers, the second space being permanently sealed.

4. A tank according to claim 1 wherein the hollow wall is configured to define a plurality of second compartments, the plurality of second compartments are adapted to be selectively displaced between flooded conditions and purged conditions to control descent and/or ascent of the tank.

5. A tank according to claim 3 wherein the ratio of volumetric space between the main storage area and the plurality of second compartments is such that (1) when the main storage area is fully flooded, the tank remains afloat, but may be sunk or submerged by controlled flooding of at least one of first second compartments; (2) when the tank is on the seabed in the flooded state, the tank may be recovered to surface by controlled air injection into at least one second compartment and controlled water release from the at least one second compartments.

6. A tank for storage of hydrocarbon liquids on the seabed, the tank comprising a main storage area having a first compartment for storage of the hydrocarbon liquids, an outer side wall, and an inner side wall defining an hollow wall surrounding the first compartment, the hollow wall is configured to define a plurality of second compartments, the plurality of second compartments being adapted to be selectively displaced between flooded conditions and purged conditions to control submersion of the tank onto the seabed and to control ascension of the tank from the seabed, wherein the tank is adapted to:
(a) fully flood the first compartment of the storage area and flood at least partially at least one compartment of the plurality of second compartments to submerge the tank onto the seabed, and to inject air into another at least one compartment of the plurality of second compartments to control submersion of the tank onto the seabed, and
(b) inject air into the at least one compartment of the plurality of second compartments that is at least partially flooded to allow controlled evacuation of water therefrom to control ascension of the tank from the seabed.

7. A tank according to claim 6 wherein the tank is adapted to allow selection of which of the at least one compartment of the second compartments are to be at least partially flooded and which of the another at least one compartment of the second compartments are to be injected with air to control submersion of the tank onto the seabed

8. A tank according to claim 6 wherein the tank is adapted to allow selection of which of the second compartments are to be at least partially evacuated to control ascension of the tank from the seabed.

9. A tank according to claim 6 wherein the tank comprises: connecting piping, valves, pressure and water level monitoring devices, adapted to allow compartment selection and remote monitoring during: flooding, water expulsion, air injection and air release, by means of a control umbilical cable, to a vessel on surface.

10. A tank according to claim 6 wherein the tank comprises a cylindrical body, the diameter of the cylindrical body being about 25 meters and having about a height of 20 meters, the side walls being about 1 meter separation and the mass of the tank 1 being about 1500 tonne.

11. A tank according to any one of claim 6 wherein the tank comprises an upper plate and a lower plate, the upper and lower plate being compartmented to form a plurality of compartments.

12. A tank according to claim 6 wherein the tank complies with Regulation 19 dated 1992 of Annex I of the International Convention for the Prevention of Pollution from Ships (MARPOL).

13. A tank according to claim 6, for storing hydrocarbons on the seabed, the tank comprising a double wall and an entrapped water layer between the hydrocarbons and the surrounding sea for reducing the rate of heat loss to the surrounding sea and facilitating thermal management of the hydrocarbons stored in the tank.

14. A tank according to claim 6 wherein the outer side wall comprises a first outer layer and a second inner layer that is distance inboard with respect to the first outer layer to define a first space between the first inner and outer layers, the first space being permanently sealed.

15. A method for submersion of a tank for storage of hydrocarbon liquids onto the seabed, the tank comprising a main storage area having a first compartment for storage of hydrocarbon liquids, an outer side wall, and an inner side wall defining a hollow wall surrounding the first compartment of the main storage area, the hollow wall configured to define a plurality of second compartments adapted to be selectively displaced between flooded conditions and purged conditions to control submersion of the tank onto the seabed, the method comprising the steps of:
fully flooding the storage area;
at least partially flooding at least one first compartment of the plurality of second compartments to achieve substantial neutral buoyancy of the tank; and
control flooding of the at least one first compartment of the plurality of second compartments to control submersion of the tank onto the seabed and injecting air into another at least one second compartment of the plurality of second compartments to maintain equilibrium between the pressure applied by the surrounding sea and the pressure inside the another at least one second compartment and the storage area.

16. A method according to claim 15 further comprising the step of selection which of the at least one compartment of the second compartments are to be at least partially flooded and which of the another at least one compartment of the second compartments are to be injected with air to control submersion of the tank onto the seabed.

17. A method for retrieving a tank for storage of hydrocarbon liquids from a seabed, the tank comprising a main storage area having a first compartment fully flooded, an outer side wall, and an inner side wall defining a hollow wall surrounding the compartment of the main storage area, the hollow wall configured to define a plurality of compartments adapted to be selectively displaced between flooded conditions and purged conditions to control descent of the tank, the method comprising the step of:
inserting air in the flooded compartments of the second compartments and allowing ascend of the tank to the water surface, wherein the inserting of air into the compartments of the second compartments is done in a controlled manner to avoid uncontrolled ascent caused by unrestrained air space expansion, as external hydrostatic pressure reduces with reduced submergence.

18. A method according to claim 17 further comprising the step of selection of which of the second compartments are at least partially evacuated to control ascension of the tank onto the seabed.

19. A tank for storage of hydrocarbon liquids on the seabed, the tank comprising a main storage area having a compartment, an outer side wall, and an inner side wall defining an hollow wall surrounding the compartment of the main storage area, the hollow wall being configured to be selectively displaced between flooded conditions and purged conditions to control descent and/or ascent of the tank, wherein the outer side wall comprises a first outer layer and a second inner layer that is distance inboard with respect to the first outer layer to define a first space between the first inner and outer layers, the first space being permanently sealed, wherein the first space comprises a water layer for reducing the rate of heat loss to the surrounding sea and facilitating thermal management of the hydrocarbon liquids stored in the tank.
